(19) United States
(12) Patent Application Publication
(10) Pub. No.: US 2025/0384365 A1
(43) Pub. Date: Dec. 18, 2025

(54) CONTEXTUAL VISUALIZATION OF TRUSTWORTHINESS FOR SUBSURFACE DATA

(71) Applicant: Schlumberger Technology Corporation, Sugar Land, TX (US)

(72) Inventors: Daya Golwala, Pune (IN); Todd Dixon, Pune (IN); Shalaka Deshpande, Pune (IN); Fabrice Haüy, Pune (IN); Abdul Khan, Pune (IN); Abhijeet Sawant, Pune (IN)

(21) Appl. No.: 19/242,042

(22) Filed: Jun. 18, 2025

(30) Foreign Application Priority Data
Jun. 18, 2024 (IN) 202411046776

(51) Int. Cl. G06Q 10/0631

(52) U.S. Cl. CPC G06Q 10/063112

(57) ABSTRACT

A method implements contextual visualization of trustworthiness for subsurface data. The method involves displaying a version train view for a hierarchical collection of a set of subsurface data. The version train view includes a version train element of a first version of the hierarchical collection. The version train element displays stamp data. The method further involves displaying a comparison view with a first version view of the first version and a second version view of a second version of the hierarchical collection. The method further involves comparing the first version to the second version to generate difference data. The method further involves updating the first version view and the second version view with the difference data to form an updated first version view and an updated second version view. The method further involves displaying the updated first version view and the updated second version view.

### CROSS REFERENCE TO RELATED APPLICATIONS

This application claims the benefit of India Provisional Application No. IN 202411046776, filed Jun. 18, 2024, in the Office of the Controller General of Patents, Designs & Trade Marks (CGPDTM) of the Government of India, which is incorporated by reference herein.

### BACKGROUND

The energy industry, particularly the upstream oil and gas sector, encounters substantial challenges in managing and utilizing extensive quantities of subsurface data. Data silos and the absence of standardized data formats impede interoperability, resulting in inefficient workflows and hindering the advancement of sophisticated analytical tools. Current data management systems often necessitate expensive and time-consuming data conversions, thereby restricting the ability to utilize data for informed decision making.

Although cloud-based open-source frameworks have been developed to standardize data management, significant limitations persist. For instance, consolidating relevant subsurface data from various siloed sources can take several days or even weeks. Even when data is aggregated at a centralized location, the process of searching for useful data within the context of specific workflows can be equally time consuming. Furthermore, the quality of the located data remains questionable, and user interfaces may not adequately indicate whether the found data is suitable for particular processes or analyses.

### SUMMARY

In general, in one or more aspects, the disclosure relates to a method for contextual visualization of trustworthiness for subsurface data. The method involves displaying a version train view for a hierarchical collection of a set of subsurface data. The version train view includes a version train element of a first version of the hierarchical collection. The version train element displays stamp data. The method further involves displaying a comparison view with a first version view of the first version and a second version view of a second version of the hierarchical collection. The method further involves comparing the first version to the second version to generate difference data. The method further involves updating the first version view and the second version view with the difference data to form an updated first version view and an updated second version view. The method further involves displaying the updated first version view and the updated second version view.

In general, in one or more aspects, the disclosure relates to a system that includes at least one processor and an application that executes on the at least one processor. Executing the application performs displaying a version train view for a hierarchical collection of a set of subsurface data. The version train view includes a version train element of a first version of the hierarchical collection. The version train element displays stamp data. Executing the application further performs displaying a comparison view with a first version view of the first version and a second version view of a second version of the hierarchical collection. Executing the application further performs comparing the first version to the second version to generate difference data. Executing the application further performs updating the first version view and the second version view with the difference data to form an updated first version view and an updated second version view. Executing the application further performs displaying the updated first version view and the updated second version view.

In general, in one or more aspects, the disclosure relates to a non-transitory computer readable medium including instructions executable by at least one processor. Executing the instructions performs displaying a version train view for a hierarchical collection of a set of subsurface data. The version train view includes a version train element of a first version of the hierarchical collection. The version train element displays stamp data. Executing the instructions further performs displaying a comparison view with a first version view of the first version and a second version view of a second version of the hierarchical collection. Executing the instructions further performs comparing the first version to the second version to generate difference data. Executing the instructions further performs updating the first version view and the second version view with the difference data to form an updated first version view and an updated second version view. Executing the instructions further performs displaying the updated first version view and the updated second version view.

Other aspects of one or more embodiments may be apparent from the following description and the appended claims.

### BRIEF DESCRIPTION OF DRAWINGS

FIG. 1 shows a diagram in accordance with the disclosure.

FIG. 2 shows a method in accordance with the disclosure.

FIG. 3.1, FIG. 3.2, FIG. 3.3, FIG. 4.1, FIG. 4.2, FIG. 5.1, FIG. 5.2, FIG. 5.3, FIG. 6.1, FIG. 6.2, FIG. 6.3, FIG. 7.1, FIG. 7.2, and FIG. 7.3 show examples in accordance with the disclosure.

FIG. 8.1 and FIG. 8.2 show computing systems in accordance with the disclosure.

Similar elements in the various figures may be denoted by similar names and reference numerals. The details of features and elements described in one figure may extend to similarly named features and elements in different figures.

### DETAILED DESCRIPTION

Systems and methods embodying the disclosure provide contextual visualization of trustworthiness in subsurface data, addressing the challenges of data silos, lack of standardized formats, and inefficient workflows. The systems include user interfaces with elements, such as the version train view, stamp view, and comparison view, which facilitate availability of the contextual information of the data, thereby ensuring only trustworthy data sharing, integration, and analysis.

The version train view allows users to view and audit the complete historical trail of the stages that the data has undergone, ensuring transparency and traceability. The stamp view enables a domain subject matter expert (SME) to review the metadata (or the complete data attributes and their values) for any version of the record and manually provide an authoritative signature by stamping the data as suitable, trusted, or certified via technical assurance. The stamping process can be defined at a workflow or persona level, ensuring that data is appropriately validated for specific uses. For example, a subject matter expert may stamp data as “trusted” and acceptable for use in a “final drilling report” by an “operations geologist” but unacceptable for “wellbore stratigraphy interpretation” by a “stratigrapher”.

The comparison view allows users to compare different versions of data, facilitating the identification of changes and ensuring that the most accurate and reliable data is used for decision making. By addressing the issues of data consolidation, search efficiency, and data quality, the systems and methods provide a robust and scalable data platform that accelerates digital transformation and drives innovation within the energy industry.

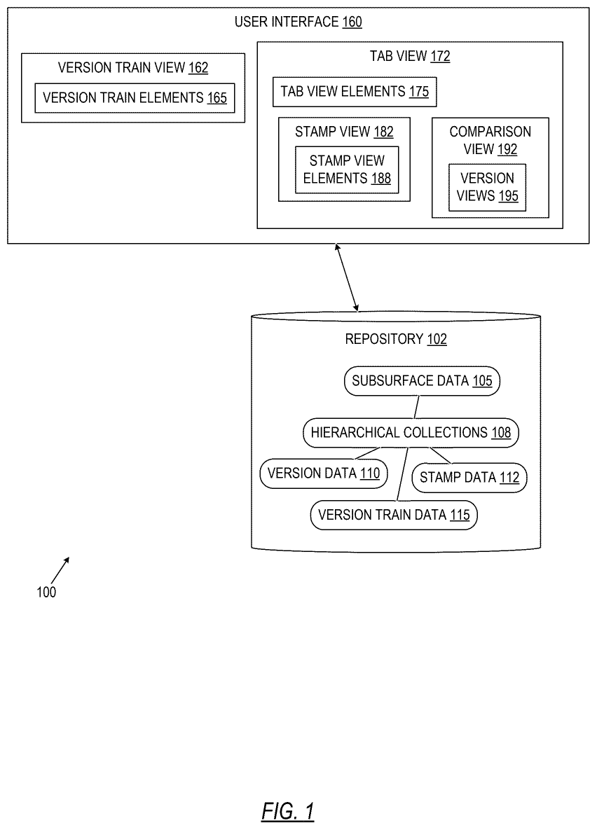

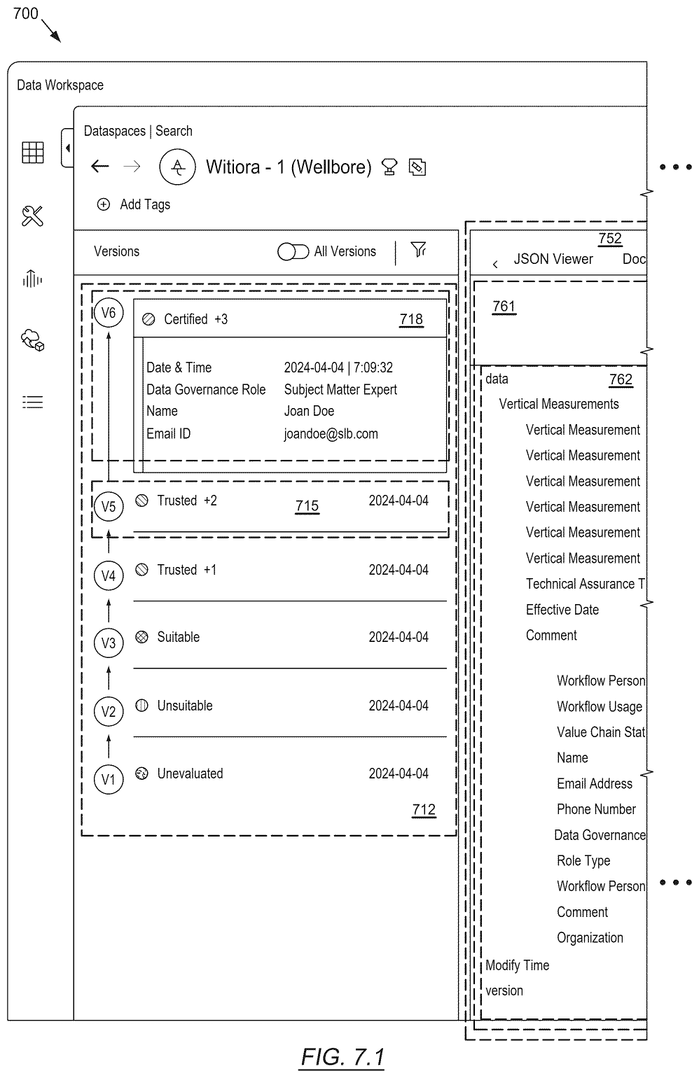

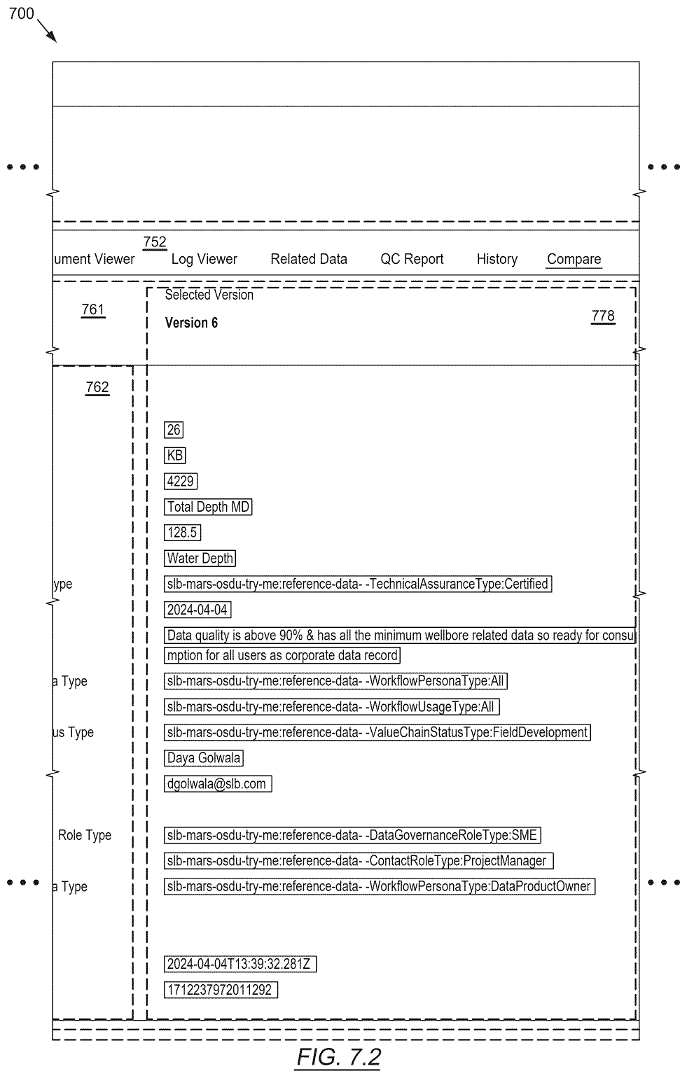

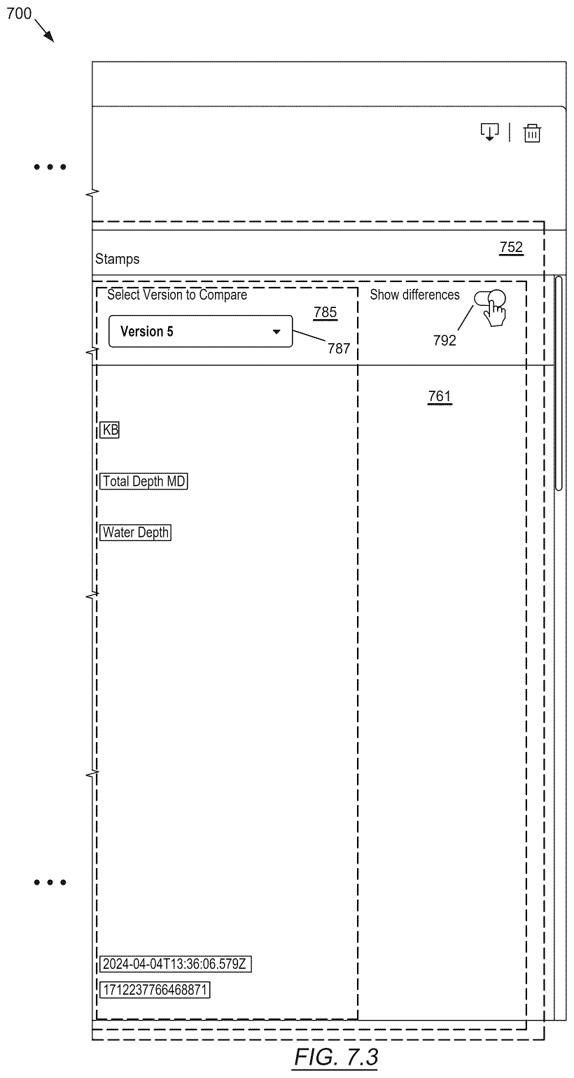

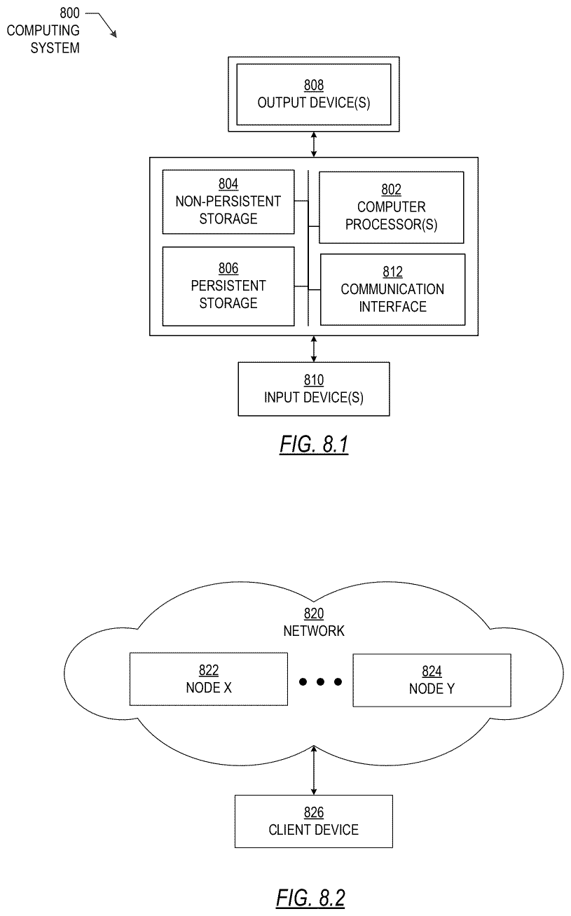

Turning to FIG. 1, the components (100) operate as part of a computing system to implement contextual visualization of trustworthiness for subsurface data. The components (100) may be part of and execute within a computing system as described in FIG. 8.1 and FIG. 8.2. The components (100) include the repository (102) and the user interface (160).

The repository (102) is a type of storage unit and/or device (e.g., a file system, database, data structure, or any other storage mechanism) for storing the data used by the system (100). The repository (102) may include multiple different, potentially heterogenous, storage units and/or devices. The repository (102) stores data utilized by other components of the system (100) and may form part of a cloud data platform. The data stored by the repository (102) may include the subsurface data (105), the hierarchical collections (108), the version data (110), the stamp data (112), the version train data (115), etc.

The subsurface data (105) is data related to measurements of subsurface phenomena that may be stored in electronic files, documents, databases, JavaScript object notation (JSON) records, in the cloud, etc. The subsurface data (105) may include many types of geological and geophysical information for energy exploration and production. The subsurface data (105) may include seismic surveys, well logs, reservoir models, etc., which may be characterized by complexity, volume, heterogeneity, etc.

The hierarchical collections (108) are structured organizations of geological and geophysical information. Elements within a hierarchical collection may be arranged in a nested, tree-like structure. Seismic surveys may be grouped by project, then by survey type, and subsequently by individual data files, while well data might be organized by field, well, and individual log types. The hierarchical collections (108) may be organized from broad geographical scales, starting with a continent/global region, narrowing to a specific region, then a province/geologic province, followed by a basin, a localized field, a hydrocarbon-bearing reservoir, a drilled well, a physical wellbore of a well, and the specific completion configuration. At each level of the hierarchy and each instance thereof, a set of files may be identified as a hierarchical collection of subsurface data. For example, a hierarchical collection for a well may include logs generated from the well. A hierarchical collection for a region may include the same logs as in the hierarchical collection for the well.

The version data (110) is data with versioning information about one of the hierarchical collections (108) of the subsurface data (105). The version data (110) is a set of metadata that may document the chronological modifications and states of individual data elements and corresponding relationships within the hierarchical structure. The version data (110) may define the history of each data component, including alterations to its content, associated metadata, and structural positioning to form a record of each iterative change to the subsurface data of a hierarchical collection.

The stamp data (112) is data with stamp information about one of the hierarchical collections (108) of the subsurface data (105). A stamp may be a data structure with reviewer elements, acceptable usage elements, unacceptable usage elements, etc. A stamp represented by the stamp data (112) may be a technical assurance construct of a standard, such as the Open Subsurface Data Universe (OSDU) standard. A stamp may identify data quality and may be a collection of information that identifies trustworthiness (meaning suitable, unsuitable, trusted, certified etc.), reviewer information, acceptable usage of the data for specific workflows by specific users, and unacceptable usage of the data for workflows or by users.

A reviewer element identifies a user that creates a stamp that is part of the stamp data (112), and may include several fields. The fields of a reviewer element may store information about the reviewer, such as name, email address, phone number, data governance role, role type, persona, comment, organization identifier, etc.

An acceptable usage element identifies usages that are acceptable of the data of the corresponding hierarchical collection and may include several fields. The fields of an acceptable usage element may store information, such as target persona, target workflow, business phase, etc., to identify an acceptable usage of the subsurface data of one of the hierarchical collections (108).

An unacceptable usage element identifies usages that are unacceptable of the data of the corresponding hierarchical collection and may include several fields. The fields of an unacceptable usage element may also store information, such as target persona, target workflow, business phase, etc., to identify an unacceptable usage of the subsurface data of one of the hierarchical collections (108).

The version train data (115) is a set of the version data (110) for one of the hierarchical collections (108) of the subsurface data (105). A version train of the version train data (115) may include information for each of the versions of one of the hierarchical collections (108).

The user interface (160) is an aggregate of visual and interactive elements (user interface elements) through which the functionality of a program may operate. The user interface elements of the user interface (160) include graphical components such as buttons, menus, display panels, etc., as well as the input elements, such as text fields, drop down boxes, selection lists, interactive controls, etc., that enable, receive, and display information in the user interface (160). The user interface (160) includes multiple user interface elements that may be displayed and interacted with to send and receive data. One user interface element (such as a view) may include a collection of multiple user interface elements. The user interface (160) includes the version train view (162) and the tab view (172).

The version train view (162) is a view of the user interface (160) that provides interaction with the version train data (115). The version train view (162) includes the version train elements (165).

The version train elements (165) are user interface elements displayed within the version train view (162) that provide interactivity with the version train data (115). One of the version train elements (165) may correspond to one version stored in the version data (110) for one of the hierarchical collections (108) of the subsurface data (105).

The tab view (172) is a view of the user interface (160) that provides interaction with the data stored in the repository (102). The tab view (172) may include the tab view elements (175), the stamp view (182), and the comparison view (192).

The tab view elements (175) are user interface elements displayed within the tab view (172) that provide interactivity with other user interface elements. The tab view elements (175) may include buttons that, when selected, control the display other views, such as the stamp view (182) and the comparison view (192).

The tab view elements (175) may be selected to display contextualized information for the versions of the subsurface data (105) within the repository (102), including meta data (which may be displayed in a view upon selecting an overview tab), other related data (which may be displayed in a view upon selecting a related data tab), data trustworthiness (which may be displayed in a view upon selecting a stamps tab), data comparisons (which may be displayed in a view upon selecting a comparison tab).

The stamp view (182) is a view of the user interface (160) that provides interaction with the stamp data (112). The stamp view (182) includes the stamp view elements (188).

The stamp view elements (188) are user interface elements displayed within the stamp view elements (188) that provide interactivity with the stamp data (112). One of the stamp view elements (188) may correspond to one stamp stored in the stamp data (112) for one version of one of the hierarchical collections (108) of the subsurface data (105).

The comparison view (192) is a view of the user interface (160) that provides interaction with the subsurface data (105). The comparison view (192) includes the version views (195).

The version views (195) are views of the user interface (160) within the comparison view (192) that provide interaction with the version data (110). One of the version views (195) may correspond to one version stored in the version data (110) for one of the hierarchical collections (108) of the subsurface data (105). One or more of the version views (195) may display differences between different versions of one of the hierarchical collections (108) of the subsurface data (105).

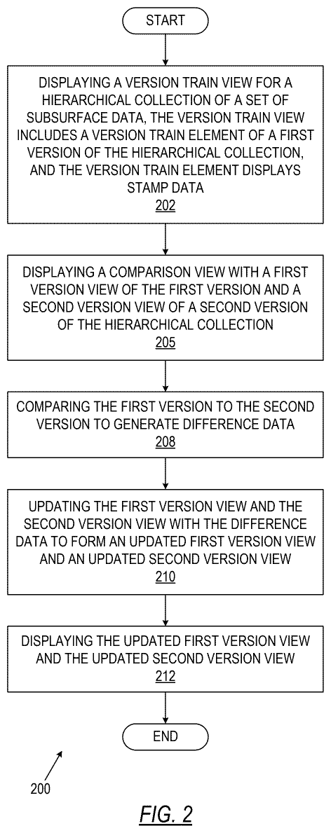

FIG. 2 shows a flowchart of a method implementing contextual visualization of trustworthiness for subsurface data. The method of FIG. 2 may be implemented using the systems described in the other figures, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the process (200) may utilize multiple views for stamps, versions, and comparisons. The process (200) may include multiple steps (e.g., Block 202 through Block 212) that may execute on the components described in the other figures, including those of FIG. 1, FIG. 8.1, and FIG. 8.2.

Block 202 includes displaying a version train view for a hierarchical collection of a set of subsurface data. The version train view includes a version train element of a first version of the hierarchical collection. The “first version” may be any version from the hierarchical collection including the initial version, the current version, any version in between, etc. The version train element displays stamp data. Displaying the version train includes transmitting version train data to a user device, which may render the version train data to a user interface.

Displaying the version train view may involve displaying the version train view with multiple version train elements. Each of the version train elements may correspond to an individual version of the hierarchical collection. The version train view is one of a plurality of views displaying contextualized information responsive to selection tab view elements comprising an overview tab button for metadata, a related tab button for related data, a stamps tab button for the stamp view with trustworthiness data, and a compare tab button for the comparison view.

Displaying the version train view may involve displaying the version train element adjacent to and above a second version train element of the multiple version train elements for the second version of the hierarchical collection. The version train elements may be displayed juxtaposed in a vertically oriented list. The “second version” may be any version from the hierarchical collection that is not the “first version” including the initial version, the current version, any version in between, etc.

Block 205 includes displaying a comparison view with a first version view of the first version and a second version view of a second version of the hierarchical collection. Displaying the comparison view includes transmitting version data to a user device that may include differences between different versions of the hierarchical collection. The user device may render the differences in the version data to a user interface. The comparison view may be displayed responsive to selecting a comparison tab element. When the comparison view is displayed, the comparison view may include a first version view and a second version view.

The comparison displayed in the comparison view may be between any two versions. One of the versions is the version selected from the version train and displayed in the first version view and the second version may be selected with a dropdown and shown in the second version view. The comparisons and the versions being compared may be with each element of information in a version.

Displaying the first version view may involve displaying first version data in the first version view. The first version view may be displayed between a header column view and a second version view. The header column view may identify the type of information displayed in the first version view and the second version view.

Displaying the second version view may involve displaying second version data in the second version view horizontally adjacent to the first version view. The second version view may be displayed with a version selector element. Interaction with the version selector element may change the version displayed within the second version view. The first version may be selected from a version train element in the version train view, which may decide the contents of displayed in the tab view, including the elements displayed within a version view. In the comparison tab the version selected from the version train view may be compared to other versions selected with the version selector to display the differences between the versions in the comparison view.

Block 208 includes comparing the first version to the second version to generate difference data. The comparison may compare fields in the first version and the second version to identify fields and the different versions that have different data. The difference data identified by the comparison may include an identification of the fields that have different data and may include the differences between the data in the same field for different versions. The first version may be selected from the version train view and the second version may be selected from the view selector within a comparison view.

Comparing the first version to the second version may involve identifying multiple differences between first version data of the first version and second version data of the second version as the difference data. Multiple fields may be identified as having differences. Multiple differences may also exist within a single field of both versions.

Block 210 includes updating the first version view and the second version view with the difference data to form an updated first version view and an updated second version view. The update to the first version and to the second version may replace data being displayed in the first version and the second version with difference data. The difference data may identify that there is a difference between values for the different versions. The user may select to ignore or hide the similarities and see the differences across the two versions of the data.

Differences and similarities between the two versions selected may be shown adjacent to each other. The user operate the user interface to ignore or hide the similarities and display the differences across the two versions of the data.

Updating the first version view and the second version view with the difference data may involve updating the first version view to include first version difference data. The first version difference data includes rows of the first version view that are filtered to show data for fields for which there is a difference between the first version and the second version. Additionally, rows may be color coded to identify rows in which the data is the same (e.g., green) and rows for which there is a difference (e.g., red).

Updating the first version view and the second version view with the difference data may involve updating the second version view to include second version difference data. The first version view and the second version view may be updated without changes to the underlying subsurface data. In concert with the first version view being updated to show fields for which there is a difference between the first version and the second version, the second version view is updated to show the portions of the data within the field for the second version that are different than the first version. The values displayed in the second version view may include highlights to indicate the differences and may the difference values from the difference data may be displayed.

Block 212 includes displaying the updated first version view and the updated second version view. Displaying the updated first version view and the updated second version view may include transmitting difference data to a user device that may render the difference data to the user interface.

Displaying the updated first version view and the updated second version view may involve displaying first version data in the first version view. Displaying the first version data in the first version view may include transmitting the first version data to a user device that may render first version data to the user interface.

Displaying the updated first version view and the updated second version view may involve displaying second version difference data in the second version view. Displaying the second version difference data in the second version view may include transmitting the second version difference data to a user device that may render second version difference data to the user interface.

Displaying the updated first version view and the updated second version view may involve displaying second version difference data in the second version view responsive to the selection of a difference selector element. Interacting with the difference selector element may trigger updating the second version view to display the difference data.

The process (200) may involve displaying a stamp view adjacent to the version train view. The stamp view includes multiple stamp view elements. The stamp view elements may be displayed juxtaposed in a vertically oriented list. The stamp view may replace the comparison view response to selection of a tab element of the user interface.

The process (200) may involve filtering a version train displayed in the version train view to generate a filtered version train. The filtering may be executed in response to the selection of a filter element of a filter view. Multiple filter elements may be displayed in the filter view. The different filter elements may identify different types of data and corresponding filter criteria for filtering the version data.

The process (200) may involve displaying the filtered version train in the version train view. The filtered version train may include version elements that correspond to versions that meet the filter criteria selected from a filter view.

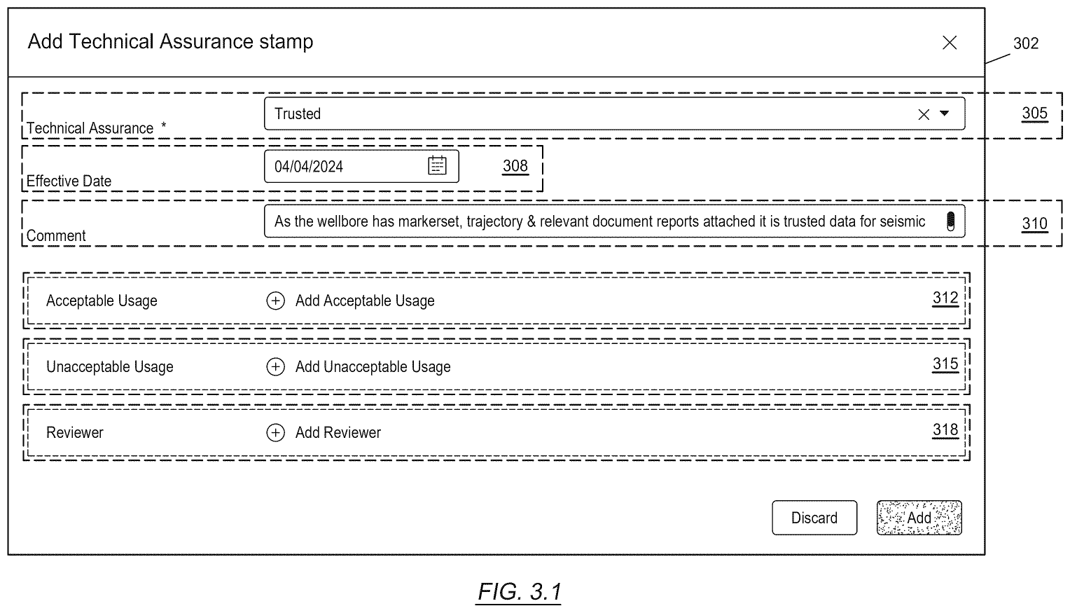

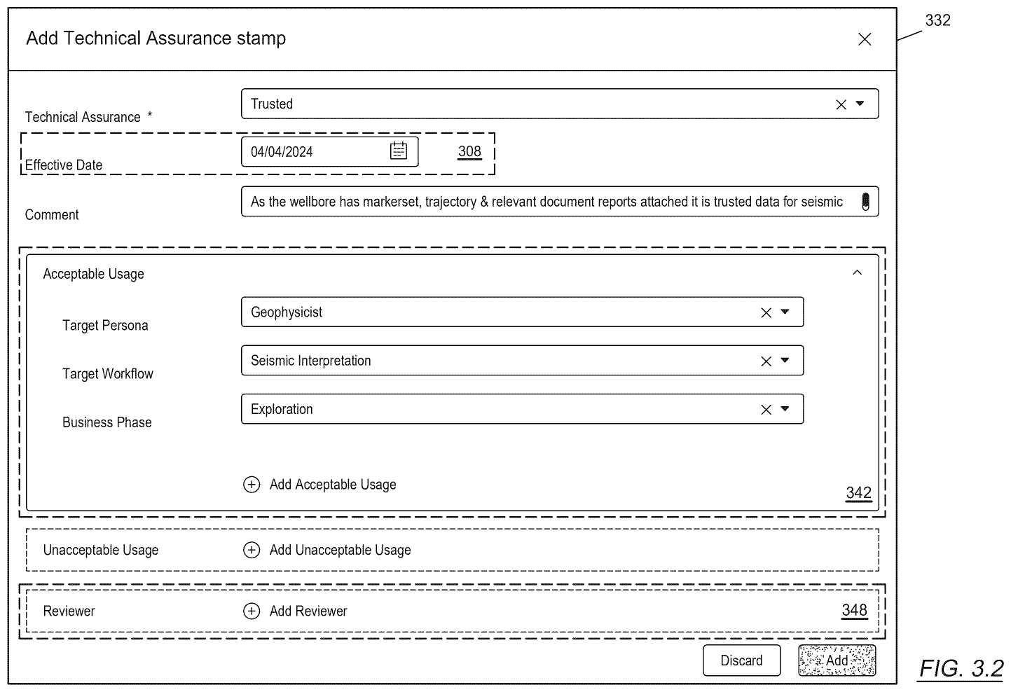

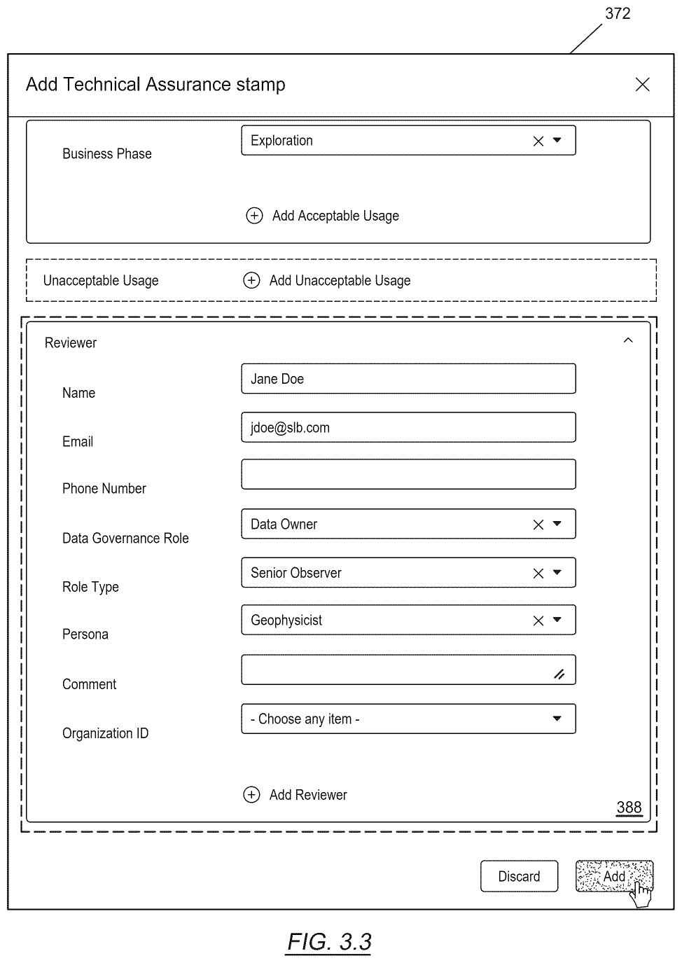

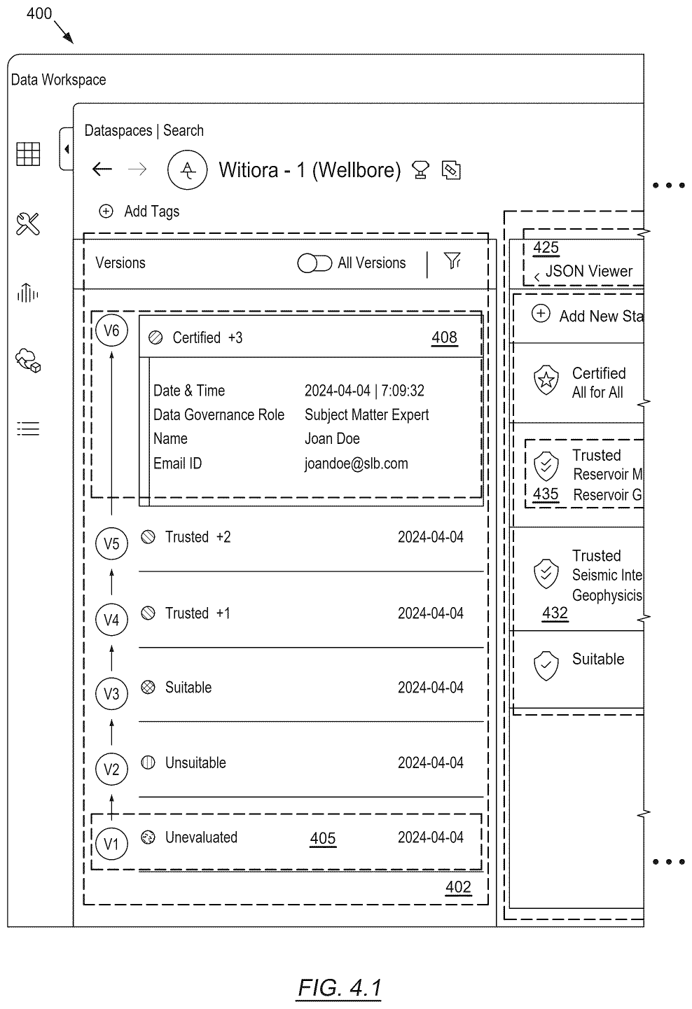

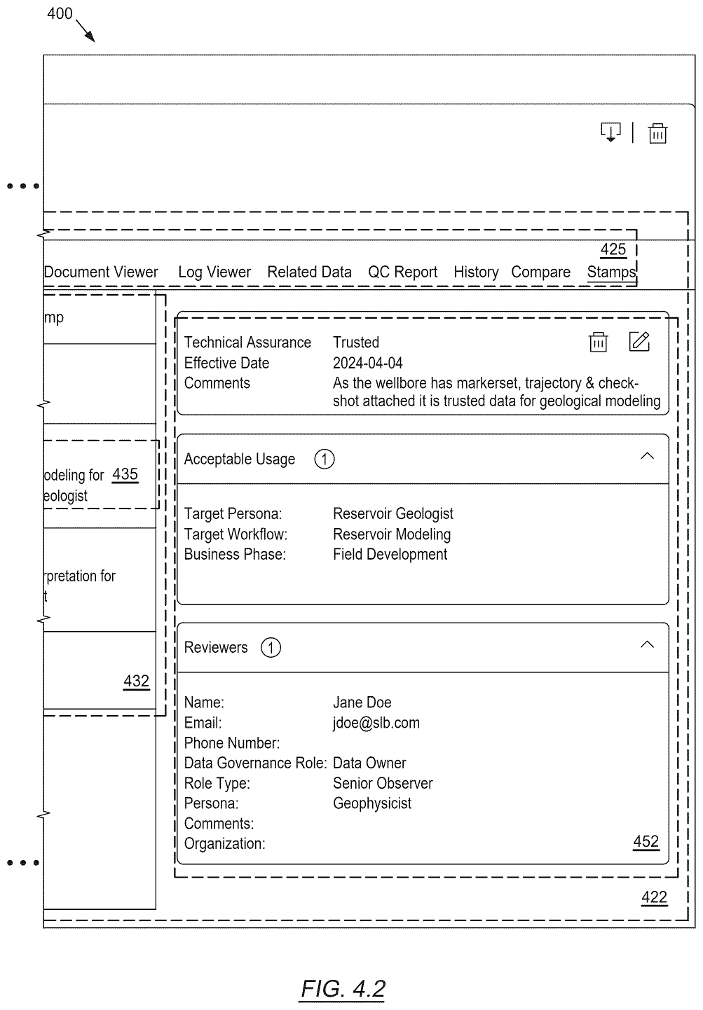

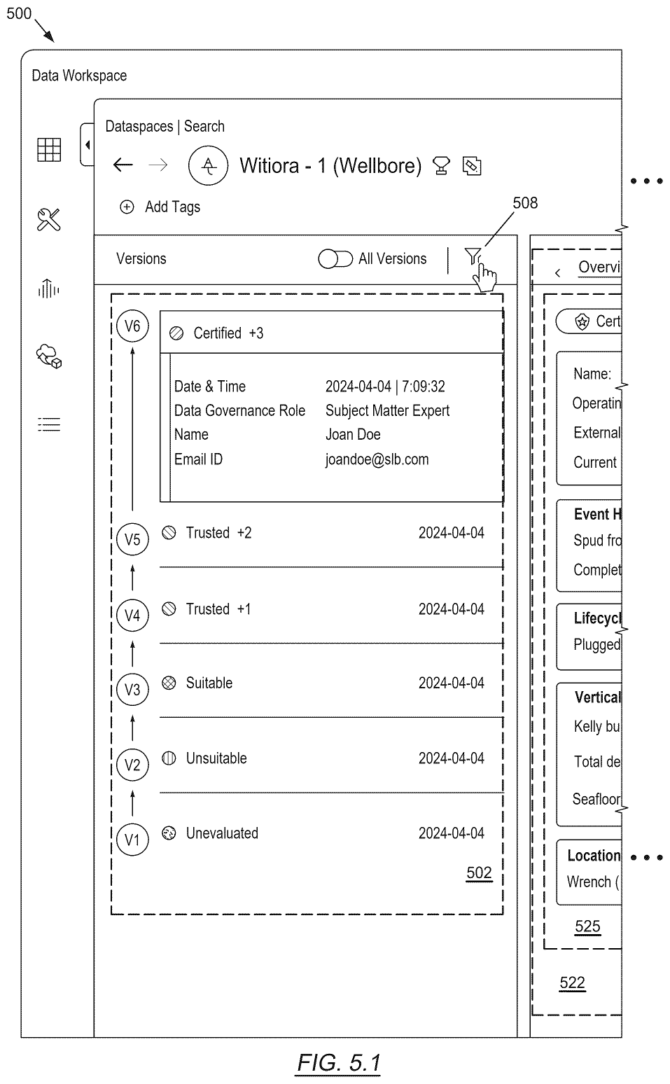

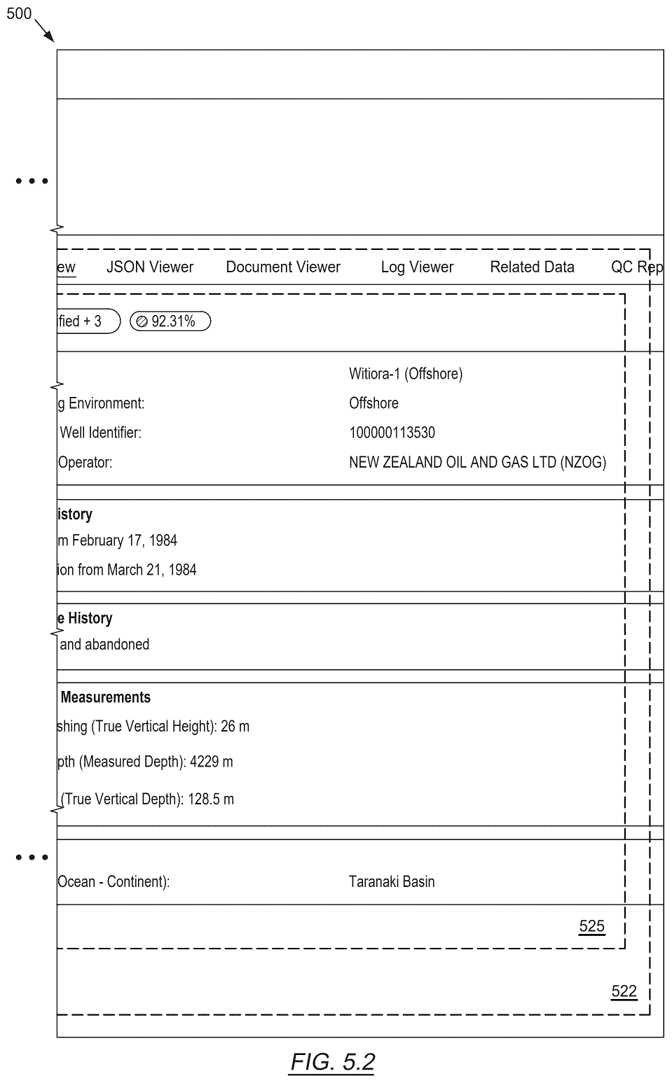

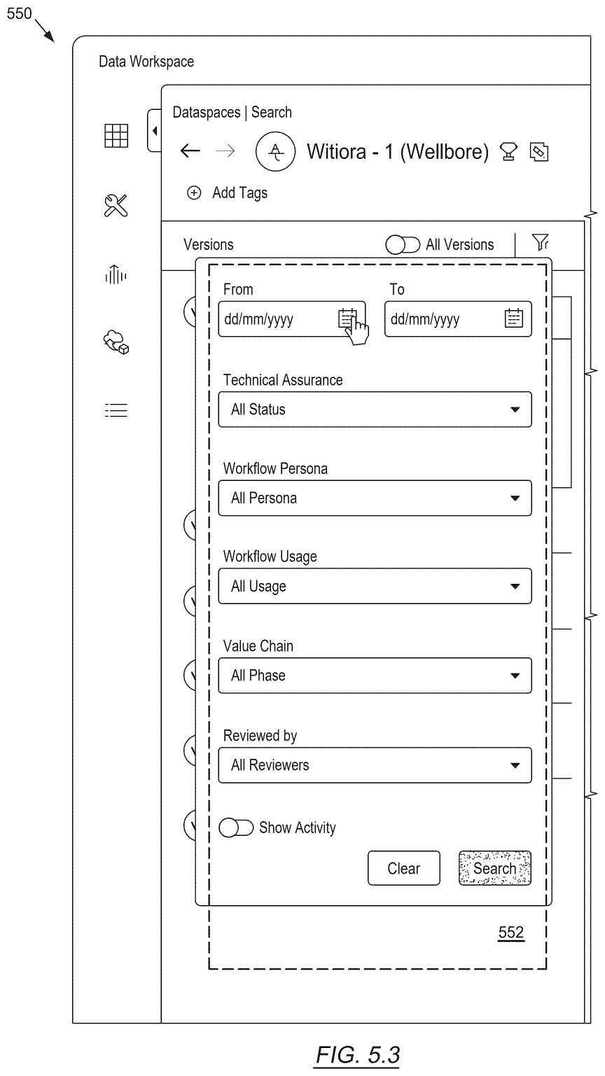

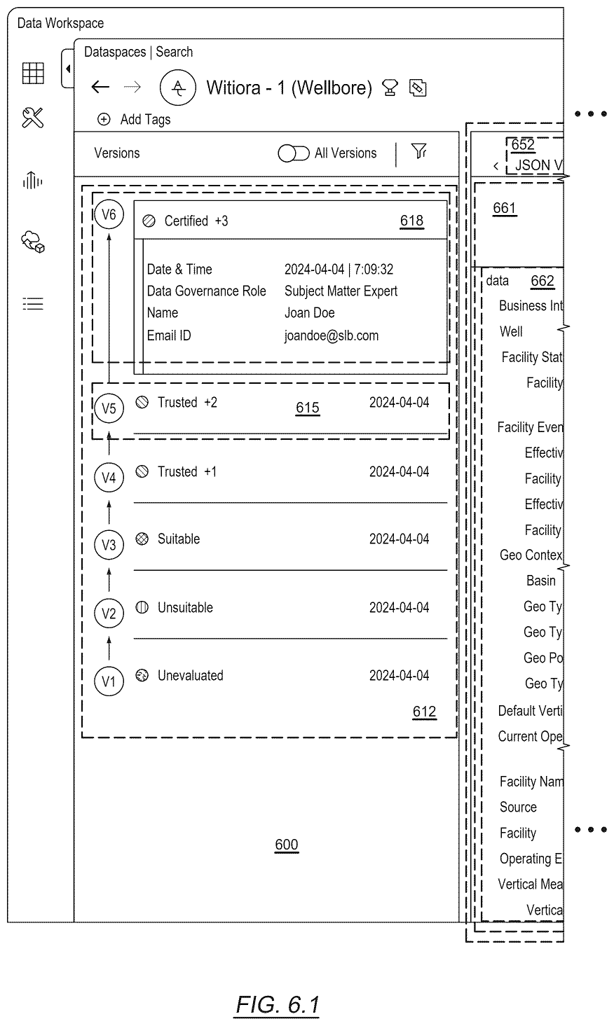

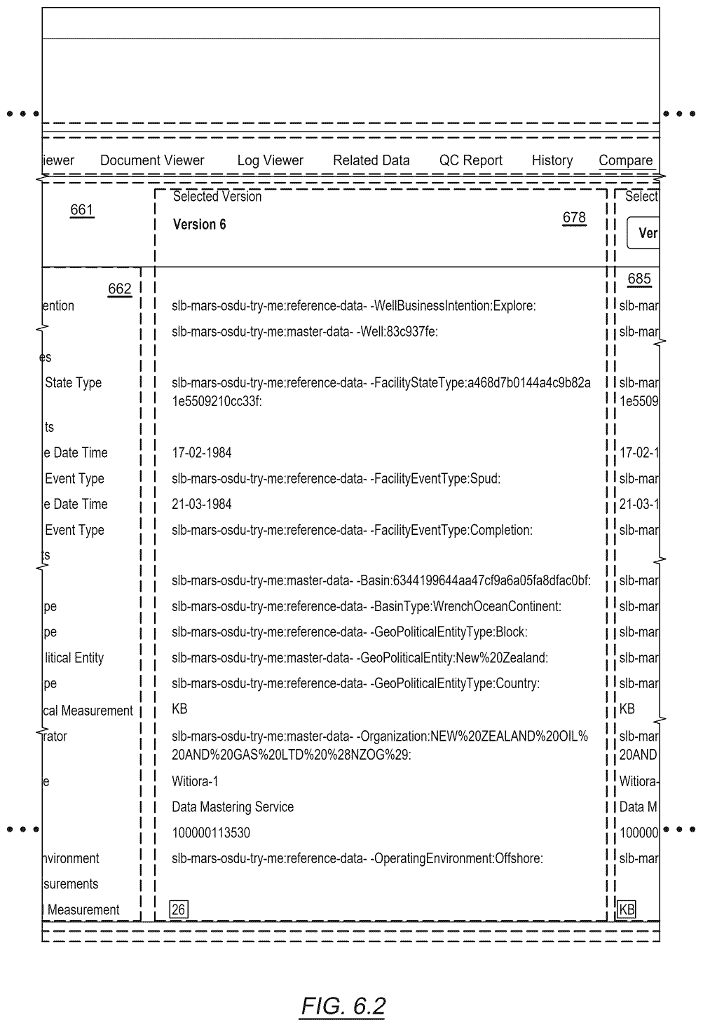

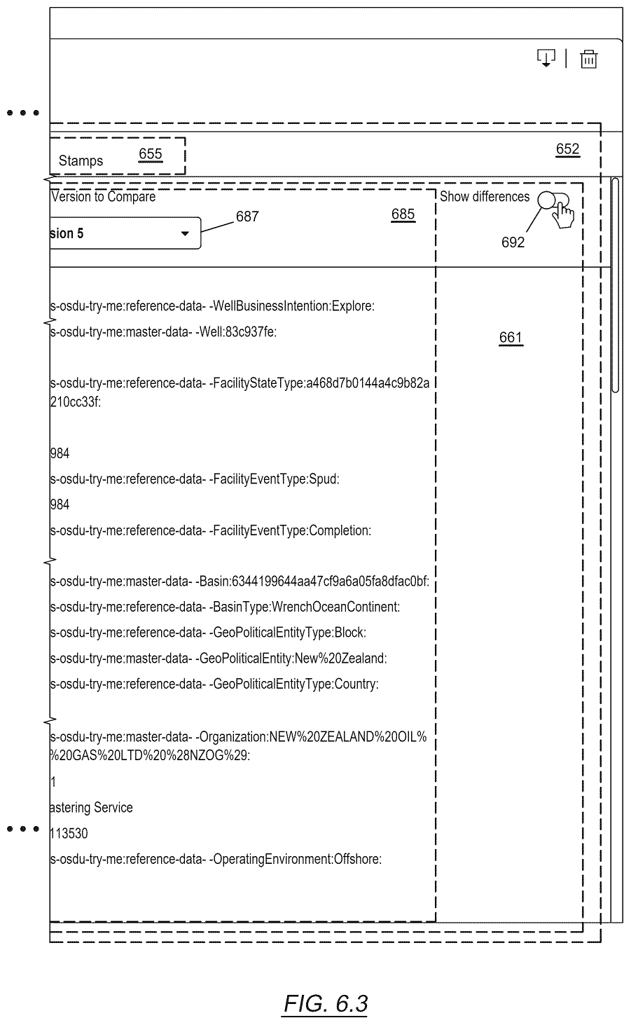

Turning to FIG. 3.1, a user interface may display the add stamp views (302), (332), and (372). The add stamp views (332) and (372) may be updated versions of the add stamp view (302) after interaction with the add stamp view (302). The add stamp view (302) includes user interface elements (305) through (318), referred to as add stamp view elements, that operate to collect information for a stamp for a hierarchical collection of subsurface data. The add stamp view elements (305) through (318) include the stamp category element (305), the stamp date element (308), the stamp comment element (310), the acceptable usage element (312), the unacceptable usage element (315), and the reviewer element (318), which are displayed vertically juxtaposed within the add stamp view (332).

The stamp category element (305) collects information that may categorize the type of stamp. The types of stamps may be identified with a label selected from a drop down box with options that include suitable, trusted, certified, etc.

The stamp date element (308) collects information related to a date for the stamp. The stamp date element (308) may collect the month, day, and year for an effective date that identifies when the stamp for which the data is being collected is effective.

The stamp comment element (310) collects information related to a comment for the stamp. The comment may be text provided by the user that provides additional information about the stamp that may not be collected with the other add stamp view elements.

The acceptable usage element (312) collects information that identifies acceptable usages for the hierarchical collection of subsurface data to which the stamp replies. The acceptable usage element (312) includes a button labeled “Add Acceptable Usage” that may be interacted with to expand the acceptable usage element (312) to receive information describing acceptable usages. One or more acceptable usages may be added to increase the accuracy in identifying the usage of the data for a workflow by a user. Similarly, multiple entries for unacceptable usages can be added.

The unacceptable usage element (315) collects information that identifies unacceptable usages for the hierarchical collection of subsurface data to which the stamp replies. The unacceptable usage element (315) includes a button labeled “Add Unacceptable Usage” that may be interacted with to expand the unacceptable usage element (315) to receive information describing unacceptable usages.

The reviewer element (318) collects information that identifies a user as a reviewer for the hierarchical collection of subsurface data to which the stamp replies. The reviewer element (318) includes a button labeled “Add Reviewer” that may be interacted with to expand the reviewer element (318) to receive information describing reviewer details.

Turning to FIG. 3.2, the add stamp view (332) is updated from the add stamp view (302) of FIG. 3.1 after selection of the button labeled “Add Acceptable Usage” in the acceptable usage element (312) of FIG. 3.1, in the add stamp view (302) of FIG. 3.1. The add stamp view (332) includes the acceptable usage element (342) and the reviewer element (348). The addition of a new stamp or modification of an existing stamp does produce a new version of the data to provide a transparent audit trail capturing what changed in the data, when the data changed, and who changed the data.

The acceptable usage element (342) is an expanded version of the acceptable usage element (312) of FIG. 3.1. The acceptable usage element (342) is expanded to include additional interface elements defining an acceptable usage. The additional interface elements defining an acceptable usage includes a set of drop down boxes that may be operated to select labels that categorize the types of information for an acceptable use. The drop down box labeled “Target Persona” identifies a type of user for the acceptable use, examples of which include geophysicist, geologist, stratigrapher, etc. The drop down box labeled “Target Workflow” identifies a type of workflow for the acceptable use, examples of which include report generation, seismic interpretation, data analysis, etc. The drop down box labeled “Business Phase” identifies a type of phase for the acceptable use, examples of which include exploration, production, etc.

The reviewer element (348) is updated from the reviewer element (318). The reviewer element (348) is shifted down responsive to the expansion of the acceptable usage element (342).

Turning to FIG. 3.3, the add stamp view (372) is updated from the add stamp view (332) of FIG. 3.2 after selection of the button labeled “Add Reviewer” in the reviewer element (348) of FIG. 3.2 in the add stamp view (332) of FIG. 3.2. The add stamp view (372) includes the reviewer element (388).

The reviewer element (388) is an expanded version of the reviewer element (348) of FIG. 3.2. The reviewer element (388) is expanded to include additional interface elements to define a reviewer. The additional interface elements defining a reviewer include a set of drop down boxes and edit boxes that may be operated to select labels and input text to describe a reviewer. The boxes labeled “Name”, “Email”, and “Phone Number” collect contact information about the reviewer. The drop down box labeled “Data Governance Role” identifies a label for the role of the reviewer, examples of which include data owner, data analyst, etc. The drop down box labeled “Role Type” identifies a label for the type of role of the reviewer, examples of which include junior observer, senior observer, etc. The drop down box labeled “Persona” identifies a label for the type of the persona of the reviewer, which may be the same as personas for the “Target Persona” drop down box from the acceptable usage element (342) of FIG. 3.2. The box labeled “Comment” collects a text string that may be input by the user for additional information about the reviewer. The drop down box labeled “Organization ID” may be operated to select an identifier for the organization of the reviewer.

FIG. 4.1 and FIG. 4.2 illustrate the user interface (400). FIG. 4.1 shows a left side of the user interface (400) and FIG. 4.2 shows a right side of the user interface (400).

Turning to FIG. 4.1, the version train view (402), the selected version train element (408), 425, the tab view elements (425), and the selected stamp element (435) are displayed within the user interface (400). The user interface (400) operates to present information for a hierarchical collection. The hierarchical collection is identified as “Witoiora-1 (Wellbore).” The user interface (400) includes multiple interactive views to present information, including the version train view (402) and the tab view (422).

The version train view (402) presents a train of versions for the hierarchical collection in a vertically juxtaposed list. The train of versions is displayed in a vertically juxtaposed list of version train elements that include the unselected version train element (405) and the selected version train element (408). The color of the circle next to the version category may be indicative of the version category. For example, red may be used for unsuitable, yellow may be used for suitable, blue may be used for trusted (e.g., Trusted+1, Trusted+2), and green may be used for Certified.

The unselected version train element (405) is a version train element that has not been selected. The unselected version train element (405) identifies the version with the label “V1”, categorized as “Unevaluated”, with a date of “2024 Apr. 4”.

The selected version train element (408) is a version train element that has been selected. Selection of a version train element expands the version train element to display additional detail about a stamp for the version. The selected version train element (408) shows additional details for the “Data Governance Role”, the name of the reviewer that created the stamp, and the email address of the reviewer that created the stamp as shown in the element (408).

The tab view (422) is another view presented within the user interface (400). The tab view (422) includes the tab view elements (425) that operate to select the type of information shown in the tab view (422).

The tab view elements (425) are selectable elements within the tab view (422). The tab view elements (425) include elements labeled as “Compare” and “Stamps”. Selection of a particular tab view element (425) causes the interface to present data in the stamp detail view (452) that corresponding to the selected tab view element. The element labeled “Compare” operates to present comparison information further described with FIG. 6.1, FIG. 6.2, FIG. 6.3, FIG. 7.1, FIG. 7.2, and FIG. 7.3. The element labeled “Stamps” operates to present the stamp view (432) and the stamp detail view (452) within the tab view (422).

The stamp view (432) presents information about the stamps for the version of the hierarchical collection corresponding to the selected version train element (408). The stamp view (432) displays a vertically juxtaposed list of stamp elements that include the selected stamp element (435).

The selected stamp element (435) presents information about a stamp for a version of the hierarchical collection of subsurface data. When the selected stamp element (435) is selected, the stamp detail view (452) is updated to display the information for the stamp that corresponds to the selected stamp element (435).

Turning to FIG. 4.2, the tab view (422), the tab view elements (425), the stamp view (432), the selected stamp element (435), and the stamp detail view (452) are displayed within the user interface (400). The stamp detail view (452) presents detailed information for a stamp for a version of a hierarchical collection of subsurface data. The stamp detail view (452) is displayed below the tab view elements (425) and beside the stamp view (432), which includes the selected stamp element (435). The stamp detail view (452) may display information collected with the add stamp views (302), (332), and (372), of FIG. 3.

FIG. 5.1 and FIG. 5.2 illustrate the user interface (500). FIG. 5.1 shows a left side of the user interface (500) and FIG. 5.2 shows a right side of the user interface (500).

Turning to FIG. 5.1, the version train view (502), the filter selector element (508), the overview view (525), and the tab view (522) are displayed within the user interface (500). The user interface (500) may be updated from the user interface (400) of FIG. 4.1 and FIG. 4.2 and operate to filter information presented in the version train view (502). The user interface (500) presents the version train view (502) and the tab view (522).

The version train view (502) presents a train of version elements. The version train view (502) is presented under the filter selector element (508). The filter selector element (508) operates to display the filter view (552) presented in the user interface (550).

Turning to FIG. 5.2, the tab view (522) and the overview view (525) are displayed within the user interface (500). On the tab view (522), the element labeled “Overview” is selected to present the overview view (525). The overview view (525) displays information from the hierarchical collection, including descriptive information (“Name”, “Operating Environment”, “Well Identifier”, “Operator”, etc.), event history, lifecycle history, vertical measurements, location, etc.

Turning to FIG. 5.3, the user interface (550) is updated from the user interface (500) of FIG. 5.1 and FIG. 5.2 to display the filter view (552). The filter view (552) is displayed in response to selection of the filter selector element (508) of FIG. 5.1.

The filter view (552) presents multiple filter elements in vertical juxtaposition. The filter elements of the filter view (552) operate to control which versions of a hierarchical collection are shown in the version train view. Versions that do not satisfy the criteria selected with the filter elements of the filter view (552) may be removed from the version train view (502) of FIG. 5.1 after selection of the element labeled “Search” in the filter view (552).

FIG. 6.1, FIG. 6.2, and FIG. 6.3 illustrate the user interface (600). FIG. 6.1 shows a left side of the user interface (600), FIG. 6.2 shows a portion of the user interface (600) juxtaposed between FIG. 6.2 and FIG. 6.3, and FIG. 6.3 shows a right side of the user interface (600).

Turning to FIG. 6.1, the unselected version train element (615), the selected version train element (618), the tab view (652), the comparison view (661), and the header column view (662) are displayed within the user interface (600). The user interface (600) operates in conjunction with the user interface (700) of FIG. 7.1, FIG. 7.2, and FIG. 7.3 to compare versions of hierarchical collections of subsurface data. The user interface (600) includes the version train view (612) and the tab view (652). The user interface (600) may be updated from the user interface (400) of FIG. 4.1 and FIG. 4.2 after selection of the tab element (425) of FIG. 4.1 and FIG. 4.2 labeled “Compare.”

The version train view (612) presents a train of versions displayed as a vertically juxtaposed list of version train elements. The version elements include the unselected version train element (615) and the selected version train element (618).

The unselected version train element (615) is a user interface element that presents information about a version “V5” the hierarchical collection. Additional information about the version to the unselected version train element (615) is displayed in the second version view (685) responsive to a selection of the second version selector (687).

The selected version train element (618) is a user interface element that presents information about a version “V6” the hierarchical collection. Responsive to the selection of the selected version train element (618), the first version view (678) is updated to display additional information about the version.

The tab view (652) presents information about the hierarchical collection of subsurface data. The tab view (652) includes the tab elements (655). The view provided by the various tabs provide relevant information for the selected version from the version train.

The tab view elements (655) operate to control the information displayed within the tab view (652). The button labeled compare is selected from the tab view elements (655) to display the comparison view (661).

The comparison view (661) presents information comparing versions of a hierarchical collection of subsurface data. The comparison view (661) includes the header column view (662), the first version view (678), the second version view (685), and the difference selector element (692).

The header column view (662) presents a header column that may be adjacent to (e.g., to the left of) the first version view (678). Information in the rows of the header column of the header column view (662) identifies the type of information in corresponding rows of the first version view (678) and the second version view (685).

Turning to FIG. 6.2, the comparison view (661), the header column view (662), the first version view (678), and the second version view (685) are displayed within the user interface (600).

The first version view (678) presents information from a first version of the hierarchical collection of subsurface data. The first version is the version identified by the selected version train element (618).

Turning to FIG. 6.3, the tab view (652), the tab view elements (655), the comparison view (661), the second version view (685), the second version selector (687), and the difference selector element (692) are displayed within the user interface (600). The second version view (685) presents information from a second version of the hierarchical collection of subsurface data. The second version is the version corresponding to the version of the unselected version train element (615) as selected with the second version selector (687).

The second version selector (687) is a user interface element displayed within the second version view (685). The second version of selector (687) is presented as a drop down box that may be interacted with to identify the version of the hierarchical collection of subsurface data that is to be used as the second version for comparison with the first version. Responsive to interaction from a user, second version selector (687) identifies the version “V5” as the second version, which corresponds to the unselected version train element (615). In other words, the fifth version of the data (“V5”) is selected to be the “second version” shown in the comparison, which compares a first version and a second version in which the first version and the second version may be any two of the versions of the data. Changing the selection within the second version selector (687) may trigger the second version view (685) to update with information from the version that corresponds to the version selected with the second version selector (687).

The difference selector element (692) is a user interface element displayed within the tab comparison view (661). The difference selector element (692) operates to control the display of the header column view (662), the first version view (678), and the second version view (685). When in a first position (e.g., when “show differences” has a value of “false” or “0”) as shown in FIG. 6.3, the header column view (662), the first version view (678), and the second version view (685) show version information from the first and second versions of hierarchical collection of subsurface data. When in a second position (e.g., when “show differences” has a value of “true” or “1”) (an example of which is shown in FIG. 7), the header column view (662), the first version view (678), and the second version view (685) are updated to show difference data that identifies differences in the information between the first and second versions of hierarchical collection of subsurface data.

FIG. 7.1, FIG. 7.2, and FIG. 7.3 illustrate the user interface (700). FIG. 7.1 shows a left side of the user interface (700), FIG. 7.2 shows a portion of the user interface (700) juxtaposed between FIG. 7.2 and FIG. 7.3, and FIG. 7.3 shows a right side of the user interface (700).

Turning to FIG. 7.1, the version train view (712), the unselected version train element (715), the selected version train element (718), the tab view (752), the comparison view (761), and the header column view (762) are displayed within the user interface (700). The user interface (700) operates in conjunction with the user interface (600) of FIG. 6.1, FIG. 6.2, and FIG. 6.3 to compare versions of hierarchical collections of subsurface data. The user interface (700) includes the version train view (712) and the tab view (752). The version train view (712) along with the unselected version train element (715) and the selected version train element (718) are similar to the corresponding elements (612), (615), and (618) from FIG. 6. The comparison view (761) within the tab view (752) is updated from the comparison view (661) from FIG. 6.1, FIG. 6.2, and FIG. 6.3 responsive to the change to the difference selector element (792) of FIG. 7.3 from a first position (in FIG. 6.3) to the second position shown in FIG. 7.3 (e.g., when “show differences” has a value of “true” or “1”).

The information in the header column view (762), the first version view (778), and the second version view (785) of FIG. 7.3 are updated from the views (662), (678), and (685) of FIG. 6.1, FIG. 6.2, and FIG. 6.3 to show information that is different between the versions selected from the version train view (712) (with the selected version train element (718)) and from the second version selector (787) of FIG. 7.3.

The header column view (762) may be updated to show rows for which there are differences between the versions of the hierarchical collection of subsurface data. The update to the header column view (762) may be performed by removing rows for which there are no difference between the versions.

Turning to FIG. 7.2, the tab view (752), the comparison view (761), the header column view (762), and the first version view (778) are displayed within the user interface 700. The first version view (778) is updated. The first version view (778) is updated to display information from the first version for which there may be differences to the second version.

Turning to FIG. 7.3, the tab view (752), the comparison view (761), the second version view (785), the second version selector (787), and the difference selector element (792) are displayed within the user interface (700). The second version view (785) is updated to display information that is different between the first version and the second version. In the second version view (785) the differences between the values for the first version and the second version may further be identified by highlighting the differences between the values a different color (e.g., shaded green).

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 8.1, the computing system (800) may include one or more computer processor(s) (802), non-persistent storage device(s) (804), persistent storage device(s) (806), a communication interface (808) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) (802) may be one or more cores, or micro-cores, of a processor. The computer processor(s) (802) includes one or more processors. The computer processor(s) (802) may include a central processing unit (CPU), a graphics processing unit (GPU), a tensor processing unit (TPU), combinations thereof, etc.

The input device(s) (810) may include a touchscreen, keyboard, mouse, microphone, touchpad, electronic pen, or any other type of input device. The input device(s) (810) may receive inputs from a user that are responsive to data and messages presented by the output device(s) (812). The inputs may include text input, audio input, video input, etc., which may be processed and transmitted by the computing system (800) in accordance with one or more embodiments. The communication interface (808) may include an integrated circuit for connecting the computing system (800) to a network (not shown) (e.g., a local area network (LAN), a wide area network (WAN), such as the Internet, mobile network, or any other type of network) or to another device, such as another computing device, and combinations thereof.

Further, the output device(s) (812) may include a display device, a printer, external storage, or any other output device. One or more of the output device(s) (812) may be the same or different from the input device(s) (810). The input device(s) (810) and output device(s) (812) may be locally or remotely connected to the computer processor(s) (802). Many different types of computing systems exist, and the aforementioned input device(s) (810) and output device(s) (812) may take other forms. The output device(s) (812) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium, such as a solid state drive (SSD), compact disk (CD), digital video disk (DVD), storage device, a diskette, a tape, flash memory, physical memory, or any other computer readable storage medium, which may be part of a cloud environment. Specifically, the software instructions may correspond to computer readable program code that, when executed by the computer processor(s) (802), is configured to perform one or more embodiments, which may include transmitting, receiving, presenting, and displaying data and messages described in the other figures of the disclosure.

The computing system (800) in FIG. 8.1 may be connected to, or be a part of, a network. For example, as shown in FIG. 8.2, the network (820) may include multiple nodes (e.g., node X (822) and node Y (824), as well as extant intervening nodes between node X (822) and node Y (824)). Each node may correspond to a computing system, such as the computing system shown in FIG. 8.1, or a group of nodes combined may correspond to the computing system shown in FIG. 8.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822) and node Y (824)) in the network (820) may be configured to provide services for a client device (826). The services may include receiving requests and transmitting responses to the client device (826). For example, the nodes may be part of a cloud computing system. The client device (826) may be a computing system, such as the computing system shown in FIG. 8.1. Further, the client device (826) may include or perform all or a portion of one or more embodiments.

The computing system of FIG. 8.1 may include functionality to present data (including raw data, processed data, and combinations thereof), such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
displaying a version train view for a hierarchical collection of a set of subsurface data, wherein the version train view comprises a version train element of a first version of the hierarchical collection, and wherein the version train element displays stamp data;
displaying a comparison view with a first version view of the first version and a second version view of a second version of the hierarchical collection;
comparing the first version to the second version to generate difference data;
updating the first version view and the second version view with the difference data to form an updated first version view and an updated second version view; and
displaying the updated first version view and the updated second version view.

2. The method of claim 1, wherein displaying the version train view comprises:
displaying the version train view with a plurality of version train elements comprising the version train element, wherein the version train view is one of a plurality of views displaying contextualized information responsive to selection tab view elements comprising an overview tab button for metadata, a related tab button for related data, a stamps tab button for the stamp view with trustworthiness data, and a compare tab button for the comparison view; and
displaying the version train element adjacent to and above a second version train element of the plurality of version train elements for the second version of the hierarchical collection.

3. The method of claim 1, wherein displaying the first version view comprises:
displaying first version data in the first version view.

4. The method of claim 1, wherein displaying the second version view comprises:
displaying second version data in the second version view horizontally adjacent to the first version view.

5. The method of claim 1, wherein comparing the first version to the second version comprises:
identifying a plurality of differences between first version data of the first version and second version data of the second version as the difference data.

6. The method of claim 1, wherein updating the first version view and the second version view with the difference data comprises:
updating the first version view to include first version difference data; and
updating the second version view to include second version difference data.

7. The method of claim 1, wherein displaying the updated first version view and the updated second version view comprises:
displaying first version data in the first version view; and
displaying second version difference data in the second version view.

8. The method of claim 1, wherein displaying the updated first version view and the updated second version view comprises:
displaying second version difference data in the second version view responsive to selection of a difference selector element.

9. The method of claim 1, further comprising:
displaying a stamp view adjacent to the version train view, wherein the stamp view comprises a plurality of stamp view elements.

10. The method of claim 1, further comprising:
filtering a version train displayed in the version train view to generate a filtered version train; and
displaying the filtered version train in the version train view.

11. A system comprising:
at least one processor; and
an application that, when executing on the at least one processor, performs stored operations comprising:
displaying a version train view for a hierarchical collection of a set of subsurface data, wherein the version train view comprises a version train element of a first version of the hierarchical collection, and wherein the version train element displays stamp data;
displaying a comparison view with a first version view of the first version and a second version view of a second version of the hierarchical collection;
comparing the first version to the second version to generate difference data;
updating the first version view and the second version view with the difference data to form an updated first version view and an updated second version view; and
displaying the updated first version view and the updated second version view.

12. The system of claim 11, wherein displaying the version train view comprises:
displaying the version train view with a plurality of version train elements comprising the version train element, wherein the version train view is one of a plurality of views displaying contextualized information responsive to selection tab view elements comprising an overview tab button for metadata, a related tab button for related data, a stamps tab button for the stamp view with trustworthiness data, and a compare tab button for the comparison view; and
displaying the version train element adjacent to and above a second version train element of the plurality of version train elements for the second version of the hierarchical collection.

13. The system of claim 11, wherein displaying the first version view comprises:
displaying first version data in the first version view.

14. The system of claim 11, wherein displaying the second version view comprises:
displaying second version data in the second version view horizontally adjacent to the first version view.

15. The system of claim 11, wherein comparing the first version to the second version comprises:
identifying a plurality of differences between first version data of the first version and second version data of the second version as the difference data.

16. The system of claim 11, wherein updating the first version view and the second version view with the difference data comprises:
updating the first version view to include first version difference data; and
updating the second version view to include second version difference data.

17. The system of claim 11, wherein displaying the updated first version view and the updated second version view comprises:
displaying first version data in the first version view; and
displaying second version difference data in the second version view.

18. The system of claim 11, wherein displaying the updated first version view and the updated second version view comprises:
displaying second version difference data in the second version view responsive to selection of a difference selector element.

19. The system of claim 11, wherein the application performs stored operations further comprising:
displaying a stamp view adjacent to the version train view, wherein the stamp view comprises a plurality of stamp view elements.

20. A non-transitory computer readable medium comprising stored instructions executable by at least one processor to perform:
displaying a version train view for a hierarchical collection of a set of subsurface data, wherein the version train view comprises a version train element of a first version of the hierarchical collection, and wherein the version train element displays stamp data;
displaying a comparison view with a first version view of the first version and a second version view of a second version of the hierarchical collection;
comparing the first version to the second version to generate difference data;
updating the first version view and the second version view with the difference data to form an updated first version view and an updated second version view; and
displaying the updated first version view and the updated second version view.
